(19) United States
(12) Patent Application Publication
(10) Pub. No.: US 2015/0077196 A1
(43) Pub. Date: Mar. 19, 2015

(54) Dielectric Waveguide Input/Output Structure and Dielectric Waveguide Duplexer Using the Same

(71) Applicant: TOKO, INC., Tsurugashima-shi (JP)

(72) Inventor: Yukikazu YATABE, Wako-shi (JP)

(21) Appl. No.: 14/485,383

(22) Filed: Sep. 12, 2014

(30) Foreign Application Priority Data
Sep. 13, 2013 (JP) 2013-189934

(51) Int. Cl. H01P 1/213; H01P 5/12; H01P 7/10; H01P 5/08

(52) U.S. Cl. CPC H01P 1/213; H01P 3/16; H01P 5/087; H01P 5/12; H01P 7/10
USPC 333/135; 333/137

(57) ABSTRACT

The present invention provides a dielectric waveguide input/output structure for connecting to a coaxial connector a plurality of dielectric waveguide resonators each comprising an approximately parallelepiped-shaped dielectric block, wherein the plurality of dielectric waveguide resonators include a first dielectric waveguide resonator and a second dielectric waveguide resonator each having an exterior coated with an electrically conductive film, except for a coupling window, wherein each of the coupling window is formed with a probe composed of an electrically conductive film, the probe having one end connected to a feeding point, and the other end connected to the electrically conductive film, and wherein the first dielectric waveguide resonator and the second dielectric waveguide resonator are arranged in such a manner that the one side surfaces thereof are located in opposed relation to each other.

### CROSS-REFERENCE TO RELATED APPLICATION

The present application claims the benefit of priority based on Japanese Patent Application No. 2013-189934 filed on Sep. 13, 2013, the contents of which are incorporated herein by reference.

### BACKGROUND OF THE INVENTION

1. Field of the Invention

The present invention relates to an input/output structure for connecting an antenna to a dielectric waveguide, and, in particular, to a duplexer used for separating a transmission channel from a reception channel.

2. Description of the Related Art

There has been a dielectric waveguide duplexer comprising a plurality of dielectric waveguide resonators connected to each other via a coupling window, whereby a resonator group for transmission is combined with a resonator group for reception, in order to transmit and receive only a signal in a desired frequency band via an antenna. Generally, the duplexer is required to comprise an input/output structure having a frequency characteristic of larger bandwidth in order to cover different transmission frequency band and reception frequency band.

FIG. 8 is an exploded perspective view, as fluoroscopically viewed from a lower side, of a conventional dielectric waveguide duplexer comprising an input/output structure of a dielectric waveguide described in JP 2012-147286A. As illustrated in FIG. 8, a dielectric waveguide duplexer 90 comprises a dielectric waveguide 91a, dielectric waveguide resonators 91b, 91c, 91d, 91e, 91f, and a printed circuit board 99.

Each of the dielectric waveguide 91a and the dielectric waveguide resonators 91b, 91c, 91d, 91e, 91f has an exterior coated with an electrically conductive film 94. The dielectric waveguide resonators 91b and 91c are serially connected to each other via a coupling window 92b exposing a dielectric body, and the dielectric waveguide resonators 91d, 91e and 91f are serially connected to each other via coupling windows 92d and 92e exposing a dielectric body. The dielectric waveguide 91a and the dielectric waveguide resonator 91b are connected to each other via a coupling window 92a exposing a dielectric body.

The dielectric waveguide 91a and the dielectric waveguide resonator 91d are connected to each other via a coupling window 92c exposing a dielectric body. The dielectric waveguide 91a has a bottom surface provided with an approximately circular island-shaped electrode 93 that is connected in part to the electrically conductive film 94.

The printed circuit board 99 has a main surface provided with a ground pattern 96 and an approximately circular input/output electrode 95 insulated from the ground pattern 96, and has a rear surface provided with a microstrip line 97. One end of the microstrip line 97 is connected to the center of the input/output electrode 95 via a through-hole 98, and the other end is connected to an antenna or the like via a coaxial connector which is not illustrated.

The dielectric waveguide duplexer 90 is disposed in such a manner that the electrically conductive film 94 and the island-shaped electrode 93 are located in opposed relation to the ground pattern 96 and the input/output electrode 95 of the printed circuit board 99, respectively.

The above described dielectric waveguide duplexer 90 is configured to have a frequency characteristic of larger bandwidth by connecting in part the island-shaped electrode 93 to the electrically conductive film 94 so as to have a C-shaped exposed dielectric portion.

### BRIEF SUMMARY OF THE INVENTION

### Problem to be Solved by the Invention

The above described dielectric waveguide duplexer has the following problems: it comprises a structure for conversion between the dielectric waveguide and the microstrip, so that an area occupied by the microstrip line cannot be reduced because the microstrip line is required to have a certain level of length; it may be required to have a metal case cover on the microstrip line for measures against leakage of electromagnetic field caused by an irradiation from the microstrip line; an unwanted emission or a loss caused by concentration of electric field between the dielectric waveguide resonator and the printed circuit board cannot be avoided in the structure for conversion between the dielectric waveguide and the microstrip due to its structural reason; and it is required to have a dielectric waveguide for input/output separately from a resonator group for connecting dielectric waveguide resonator groups to each other.

The present invention has been made in view of the above problems, and the object thereof is to provide a dielectric waveguide input/output structure designed to have an input/output structure with respect to a coaxial line and a small occupied area, and to be small in volume, inexpensive and small-sized.

### Means for Solving the Problem

According to the present invention, there is provided a dielectric waveguide input/output structure for connecting to a coaxial connector a plurality of dielectric waveguide resonators each comprising an approximately parallelepiped-shaped dielectric block, wherein the plurality of dielectric waveguide resonators include a first dielectric waveguide resonator and a second dielectric waveguide resonator each having an exterior coated with an electrically conductive film, except for a coupling window provided in one side surface of the parallelepiped-shaped dielectric blocks of the first and second dielectric waveguide resonators, wherein each of the coupling window is formed with a linear-shaped probe composed of an electrically conductive film, the probe having one end connected to a feeding point which is formed on an edge of the one side surface and insulated from the electrically conductive film, and the other end connected to a portion of the electrically conductive film around an outer periphery of the coupling window, and wherein the first dielectric waveguide resonator and the second dielectric waveguide resonator are arranged in such a manner that the one side surfaces thereof are located in opposed relation to each other to allow the coupling windows thereof to be positionally aligned with each other.

### Effect of the Invention

In the dielectric waveguide input/output structure of the present invention, it is not required to convert a coaxial line into a microstrip line. This makes it possible to provide a dielectric waveguide input/output structure which is not required to have measures against leakage of electromagnetic field, and a dielectric waveguide duplexer comprising the input/output structure. Further, it is not required to have any excess dielectric waveguides. This makes it possible to reduce the number of components of the dielectric waveguide duplexer, to thereby have a reduced occupation area and volume, and to provide a dielectric waveguide input/output structure which may be inexpensive and small-sized dielectric duplexer, and a dielectric waveguide duplexer comprising this input/output structure.

### BRIEF DESCRIPTION OF THE DRAWINGS

FIG. 1 is an exploded perspective view for explaining a dielectric waveguide input/output structure according to the present invention.

FIGS. 2A and 2B are illustrations for explaining in detail the dielectric waveguide input/output structure according to the present invention.

FIG. 3 is a plain view for explaining the dielectric waveguide input/output structure according to the present invention.

FIG. 4 is a graph illustrating a normalized frequency characteristic of the dielectric waveguide input/output structure according to the present invention.

FIG. 5 is an exploded perspective view for explaining a dielectric waveguide duplexer according to the present invention.

FIG. 6 is a graph illustrating a normalized frequency characteristic of the dielectric waveguide duplexer comprising the dielectric waveguide input/output structure according to the present invention.

FIG. 7 is an illustration for explaining an alternative embodiment of the dielectric waveguide input/output structure according to the present invention.

FIG. 8 is an exploded perspective view of an example of a conventional dielectric waveguide duplexer.

### DETAILED DESCRIPTION OF THE INVENTION

(Embodiment of Input/Output Structure)

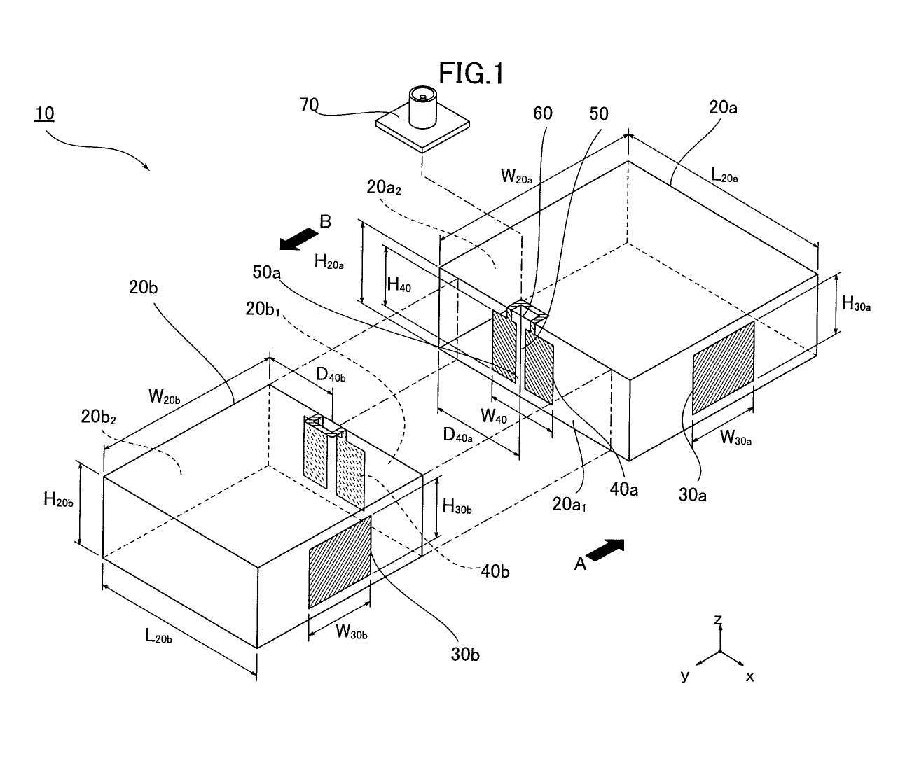

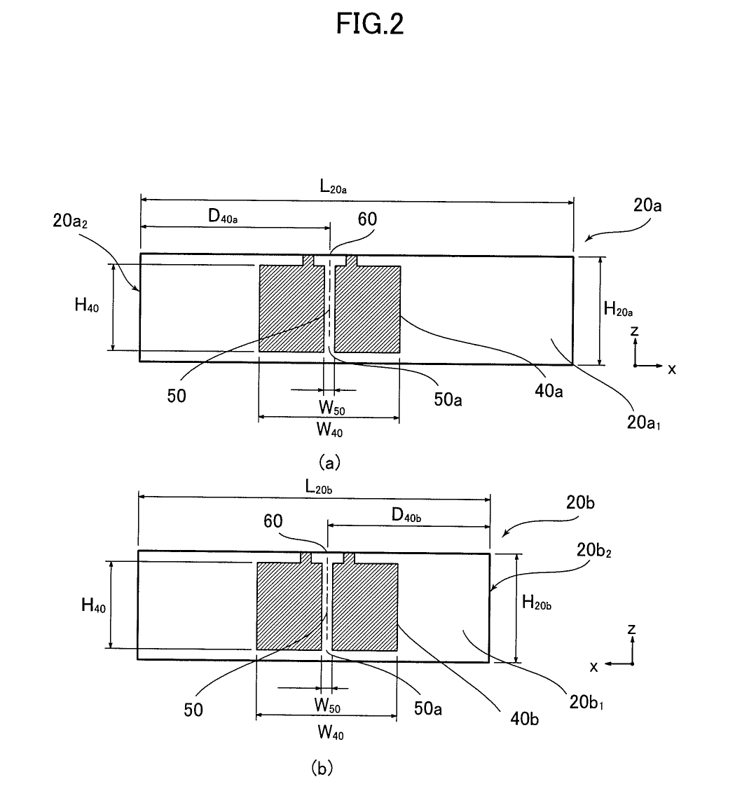

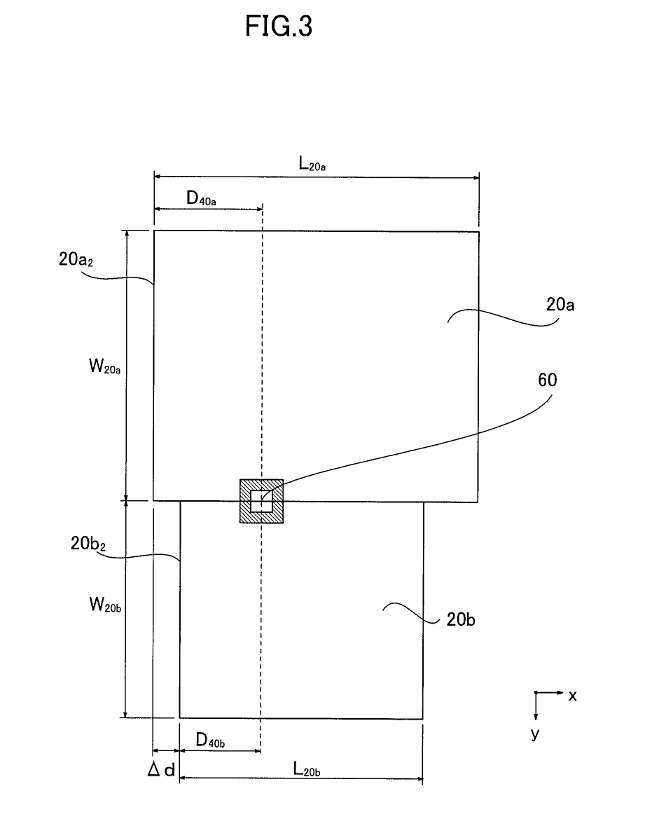

A dielectric waveguide input/output structure of the present invention will now be described with reference to FIGS. 1 to 3. FIG. 1 is an exploded perspective view, as viewed fluoroscopically, for explaining a dielectric waveguide input/output structure according to the present invention, FIG. 2A is a front view of a side surface 20a₁ of a dielectric waveguide resonator 20a, as viewed from a direction indicated by an arrow A in FIG. 1, FIG. 2B is a front view of a side surface 20b₁ of a dielectric waveguide resonator 20b, as viewed from a direction indicated by an arrow B in FIG. 1, and FIG. 3 is a plain view of the dielectric waveguide input/output structure. In FIGS. 1 to 3, the shaded area represents an exposed dielectric portion.

As illustrated in FIGS. 1 to 3, a dielectric waveguide input/output structure 10 of the present invention comprises: a dielectric waveguide resonator 20a on a lower frequency side, obtained by coating, with an electrically conductive film, an exterior of an approximately rectangular parallelepiped-shaped dielectric body having a length L₂₀ₐ, width W₂₀ₐ and thickness H₂₀ₐ; a dielectric waveguide resonator 20b on a higher frequency side, obtained by coating, with an electrically conductive film, an exterior of an approximately rectangular parallelepiped-shaped dielectric body having a length L_{20b}, width W_{20b} and thickness H_{20b}; and a coaxial connector 70.

One side surface 20a₁ of the dielectric waveguide resonator 20a and one side surface 20b₁ of the dielectric waveguide resonator 20b are provided with coupling windows 40a and 40b having a width W₄₀ and height H₄₀ and exposing the dielectric body respectively, and the dielectric waveguide resonators are arranged in such a manner that the side surfaces 20a₁ and 20b₁ are located in opposed relation to each other to allow the coupling windows 40a and 40b to be positionally aligned with each other.

Each of the coupling windows 40a and 40b comprises a linear-shaped probe 50 composed of an electrically conductive film. The probe 50 has one end connected to a feeding point 60 which is provided on an edge of each of the side surfaces 20a₁ and 20b₁ and insulated from the electrically conductive film, and the other end connected to an electrically conductive film on an outer periphery of each of the coupling windows 40a and 40b. The coaxial connector 70 is disposed on the feeding point 60.

The coupling window 40a is located away from a side surface 20a₂ positioned on the left side of the side surface 20a₁ by a distance D₄₀ₐ, and the coupling window 40b is located away from a side surface 20b₂ positioned on the right side of the side surface 20b₁ by a distance D_{40b}. That is, the dielectric waveguide resonators 20a and 20b are arranged to allow the side surfaces 20a₂ and 20b₂ to be displaced from each other by Δd (=D₄₀ₐ-D_{40b}).

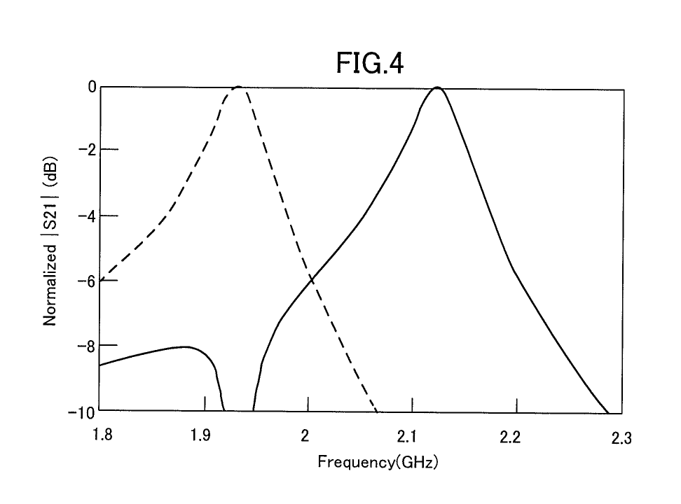

FIG. 4 is a graph illustrating a normalized frequency characteristic of the above described dielectric waveguide input/output structure. In FIG. 4, the dashed line represents a characteristic on the lower frequency side, and the solid line represents a characteristic on the higher frequency side, wherein the horizontal axis represents dB, and the vertical axis represents a frequency GHz.

In the above described embodiment, an external Q is adjustable by the distances D₄₀ₐ and D_{40b}. The external Q has an optimal value determined by each bandwidth of a transmission channel side and a reception channel side, and is generally adjusted by a width of the coupling windows or the like. In the dielectric waveguide input/output structure of the present invention, the external Q is adjustable not only by the width of the coupling windows, but also by arranging the coupling windows to be displaced from the center of width direction (direction of x-axis in the figure) of the side surfaces 20₁ and 20b₁.

The external Q may become smallest when the coupling windows 40a and 40b are arranged at the center of width direction of the side surfaces 20ₐ₁ and 20_{b1} respectively. However, the length L₂₀ₐ of the dielectric waveguide resonator 20a is different from the length L_{20b} of the dielectric waveguide resonator 20b because the dielectric waveguide resonators 20a and 20b are different from each other in terms of their frequency bands. For this reason, when the coupling windows are arranged in respective side surfaces, the side surface 20a₂ does not necessarily become coplanar with the side surface 20b₂. The dielectric waveguide resonators 20a and 20b must be arranged to allow the coupling windows 40a and 40b to be overlapped with each other, so that the positional alignment thereof becomes difficult. Then, it is also possible to arrange the coupling window 40a and/or the coupling window 40b in such a manner as to allow D₄₀ₐ and D_{40b} to be the same (namely, Δ to be 0), to thereby facilitate the positional alignment at the time of assembly.

The above described dielectric waveguide input/output structure does not comprise any dielectric waveguide for input/output separately from the resonator groups, and is comprised only of the resonator groups. This makes it possible to reduce the number of components of the dielectric waveguide duplexer, thereby to reduce the occupation area and the volume and to achieve an inexpensive dielectric duplexer. It is noted that the frequency characteristic of larger bandwidth cannot be obtained unless the other end of the probe is connected to the electrically conductive film on the outer periphery of the coupling window, so that such an unconnected structure is not suitable as an input/output structure of a duplexer.

(Embodiment of Duplexer)

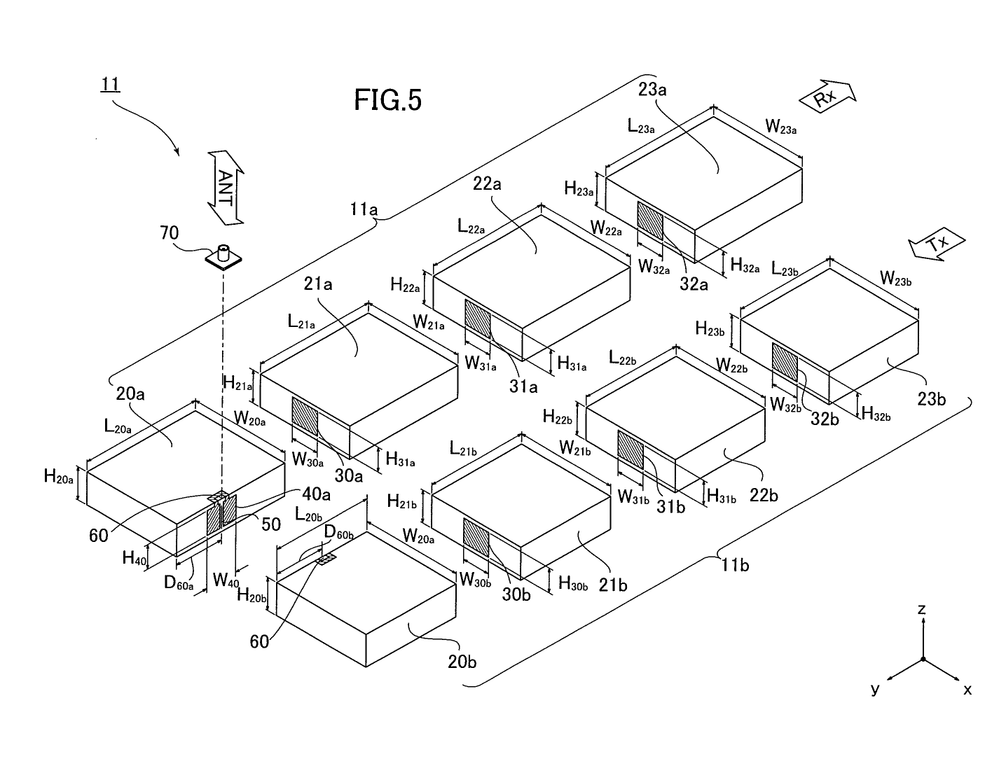

FIG. 5 is a perspective view, as viewed from an upper side, of an embodiment of a dielectric waveguide duplexer comprising the dielectric waveguide input/output structure illustrated in FIG. 1. In FIG. 5, the shaded area represents an exposed dielectric portion. Like numerals refer to the same components as in the dielectric waveguide input/output structure illustrated in FIGS. 1 to 3 and any description thereof will be omitted.

As illustrated in FIG. 5, a dielectric waveguide duplexer 11 comprises a resonator group 11 a for reception on the lower frequency side, a resonator group 11 b for transmission on the higher frequency side, and a coaxial connector 70. The resonator group 11 a comprises dielectric resonators 20a, 21a, 22a and 23a serially connected via coupling windows 30a, 31a and 32a. The resonator group 11b comprises dielectric resonators 20b, 21b, 22b and 23b serially connected via coupling windows 30b, 31b and 32b.

One side surface 20a₁ of the dielectric waveguide resonator 20a and one side surface 20b₁ of the dielectric waveguide resonator 20b are provided with coupling windows 40a and 40b respectively, and the dielectric waveguide resonators are arranged in such a manner that the side surfaces 20a₁ and 20b₁ are located in opposed relation to each other to allow the coupling windows 40a and 40b to be positionally aligned with each other.

The coaxial connector 70 is connected to an antenna which is not illustrated.

The above described dielectric waveguide duplexer 11 is capable of filtering a received signal Rx on the lower frequency side received from the antenna by the resonator group 11a, and filtering a transmission signal Tx on the higher frequency side by the resonator group 11b and transmit the signal from the antenna ANT.

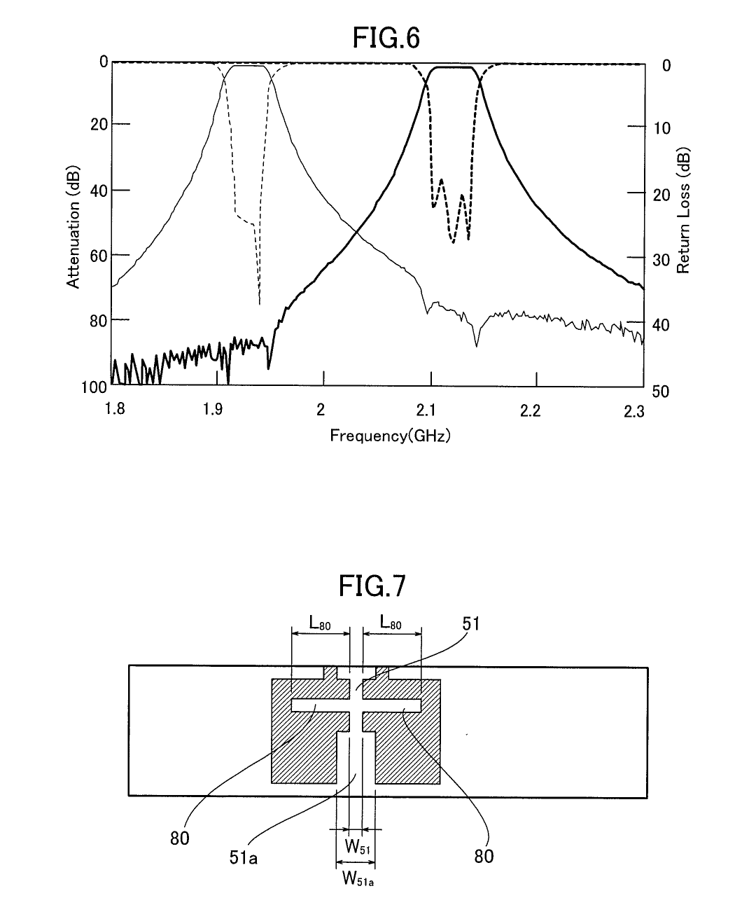

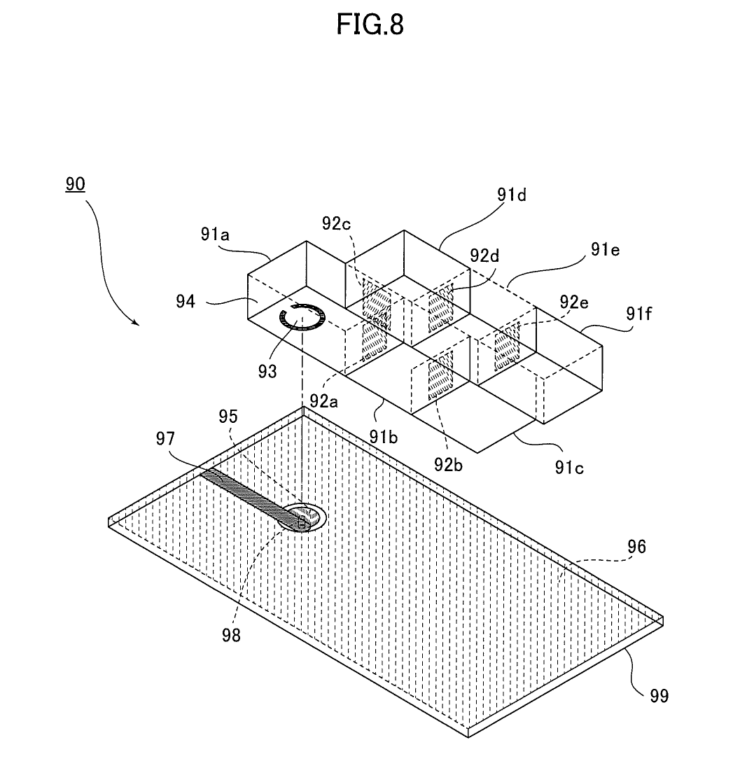

FIG. 6 is a graph illustrating a frequency characteristic of the embodiment of the dielectric waveguide duplexer 11 illustrated in FIG. 5. In the figure, the thin line represents a receiving side Rx, and the thick line represents a transmitting side Tx, wherein a return loss is represented by the dashed line, and an insertion loss is represented by the solid line.

The dielectric waveguide duplexer is designed to have the following values: center frequency of the receiving side: f0ₐ=1.93 GHz; bandwidth of the receiving side: Wₐ=20 MHz; center frequency of the transmitting side: f0_{b}=2.12 GHz; and bandwidth of the transmitting side: W_{b}=20 MHz.

The dielectric resonator 20a has a length L₂₀ₐ=25.15 mm, a width W₂₀ₐ=22 mm, and a height H₂₀ₐ=4 mm.

The dielectric resonator 21a has a length L₂₁ₐ=24.96 mm, a width W₂₁ₐ=22 mm, and a height H₂₁ₐ=4 mm.

The dielectric resonator 22a has a length L₂₂a=24.96 mm, a width W₂₂ₐ=22 mm, and a height H₂₂ₐ=4 mm

The dielectric resonator 23a has a length L₂₃ₐ=24.71 mm, a width W₂₃ₐ=22 mm, and a height H₂₃ₐ=4 mm.

The dielectric resonator 20b has a length L_{20b}=20.70 mm, a width W_{20b}=22 mm, and a height H_{20b}=4 mm.

The dielectric resonator 21b has a length L_{21b}=20.57 mm, a width W_{21b}=22 mm, and a height H_{21b}=4 mm.

The dielectric resonator 22b has a length L_{22b}=20.57 mm, a width W_{22b}=22 mm, and a height H_{22b}=4 mm.

The dielectric resonator 23b has a length L_{23b}=20.35 mm, a width W_{23b}=22 mm, and a height H_{23b}=4 mm.

The coupling window 30a has a width W₃₀ₐ=5.47 mm, and a height H₃₀ₐ=3 mm.

The coupling window 31a has a width W₃₁ₐ=4.67 mm, and a height H₃₁ₐ=3 mm.

The coupling window 32a has a width W₃₂ₐ=5.47 mm, and a height H₃₂ₐ=3 mm.

The coupling window 30b has a width W_{30b}=4.51 mm, and a height H_{30b}=3 mm.

The coupling window 31b has a width W_{31b}=3.96 mm, and a height H_{31b}=3 mm.

The coupling window 32b has a width W_{32b}=4.51 mm, and a height H_{32b}=3 mm.

The coupling window 40 has a width W₄₀=7.60 mm, and a height H₄₀=3.6 mm.

The position of the coupling window 40 is: D₄₀ₐ=6.45 mm, and D_{40b}=6.45 mm.

The width of the probe 50 is: W₅₀=1.1 mm.

The relative permittivity of the dielectric resonators 20a to 23a and 20b to 23b is 21.

FIG. 6 shows that a characteristic of narrow bandwidth and isolation between the transmission frequency Tx and the reception frequency Rx are obtained.

(Alternative Embodiment)

FIG. 7 is an illustration of a coupling window for explaining an alternative embodiment of the present invention. As illustrated in FIG. 7, by allowing a distal end 51a of a probe 51 to have a width W₅₁ₐ that is larger than the probe width W₅₁ (W₅₁ₐ>W₅₁), it becomes possible to achieve an impedance matching and reduce the external Q. Further, as illustrated in FIG. 7, it is also possible to provide a stub 80 having a length L₈₀ on opposite sides of the probe 51, to thereby suppress the third harmonic. Preferably, L₈₀ is the ¼ of a guide wavelength λ.

The probe 51 and the stub 80 may be provided in both or either one of the coupling windows 40a and 40b. Alternatively, it is also possible to provide the probe 51 in the coupling window 40a and provide the stub 80 in the coupling window 40b, so as to have a combined desired shape when the dielectric waveguide resonators 20a and 20b are arranged in opposed relation with each other.

Further, in the above embodiment, the coaxial connector is directly disposed on the dielectric waveguide resonator. Alternatively, the coaxial connector may also be disposed by interposing a printed circuit board which is slightly larger than the occupation area of the coaxial connector in order to ensure the connection strength of the coaxial connector.

### Explanation of Codes

10: dielectric waveguide input/output structure

11, 90: dielectric waveguide duplexer

11a, 11b: resonator group

20a, 21a, 22a, 23a, 20b, 21b, 22b, 23b, 91b, 91c, 91d, 91e, 91f: dielectric waveguide resonator

30a, 31a, 32a, 30b, 31b, 32b, 40a, 40b, 92a, 92b, 92c, 92d, 92e: coupling window

50, 51: probe

60: feeding point

70: coaxial connector

80: stub

91a: dielectric waveguide

93: island-shaped electrode

94: electrically conductive film

95: input/output electrode

96: ground pattern

97: microstrip line

98: through-hole

99: printed circuit board

What is claimed is:

1. A dielectric waveguide input/output structure for connecting to a coaxial connector a plurality of dielectric waveguide resonators each comprising an approximately parallelepiped-shaped dielectric block,
wherein the plurality of dielectric waveguide resonators include a first dielectric waveguide resonator and a second dielectric waveguide resonator each having an exterior surface coated with an electrically conductive film, except for one side surface in which coupling window is provided,
wherein a linear-shaped probe composed of an electrically conductive film is formed in the coupling window, the probe having one end connected to a feeding point which is formed on an edge of the one side surface and insulated from the electrically conductive film, and the other end connected to a portion of the electrically conductive film around an outer periphery of the coupling window, and
wherein the first dielectric waveguide resonator and the second dielectric waveguide resonator are arranged in such a manner that the one side surfaces thereof are opposing to each other to allow the coupling windows thereof to be aligned with each other.

2. The dielectric waveguide input/output structure as defined in claim 1, wherein the probe is provided with a stub.

3. The dielectric waveguide input/output structure as defined in claim 2, wherein the probe is provided in the coupling window of the first dielectric waveguide resonator, and the stub is provided in the coupling window of the second dielectric waveguide resonator.

4. The dielectric waveguide input/output structure as defined in any one of claims 1 to 3, wherein the one side surface of the first dielectric waveguide resonator and the one side surface of the second dielectric waveguide resonator are different in terms of a lateral length.

5. The dielectric waveguide input/output structure as defined in claim 4, wherein the coupling window of the first dielectric waveguide resonator is displaced from a center of the one side surface of the first dielectric waveguide resonator in such a manner as to allow other side surface adjacent to the one side surface of the first dielectric waveguide resonator to be coplanar with other side surface adjacent to the one side surface of the second dielectric waveguide resonator and on the same side as the other side surface of the first dielectric waveguide resonator.

6. The dielectric waveguide input/output structure as defined in claim 4, wherein the coupling window of the second dielectric waveguide resonator is displaced from a center of the one side surface of the second dielectric waveguide resonator in such a manner as to allow other side surface adjacent to the one side surface of the first dielectric waveguide resonator to be coplanar with other side surface adjacent to the one side surface of the second dielectric waveguide resonator and on the same side as the other side surface of the first dielectric waveguide resonator.

7. The dielectric waveguide input/output structure as defined in claim 4, wherein the coupling window of the first dielectric waveguide resonator is displaced from a center of the one side surface of the first dielectric waveguide resonator, and the coupling window of the second dielectric waveguide resonator is displaced from a center of the one side surface of the second dielectric waveguide resonator, in such a manner as to allow other side surface adjacent to the one side surface of the first dielectric waveguide resonator to be coplanar with other side surface adjacent to the one side surface of the second dielectric waveguide resonator and on the same side as the other side surface of the first dielectric waveguide resonator.

8. A dielectric waveguide duplexer comprising the dielectric waveguide input/output structure as defined in claim 1.
